(19) United States
(12) Patent Application Publication
(10) Pub. No.: US 2011/0217568 A1
(43) Pub. Date: Sep. 8, 2011

(54) LAYERED ARTICLE

(76) Inventors: Vinod Kumar Pareek, Albany, NY (US); Yuk-Chiu Lau, Ballston Lake, NY (US); Joshua Lee Margolies, Niskayuna, NY (US); Michel Marie Moliere, Belfort (FR); Dmitry Sokolov, BUC Franche Comte (FR)

(21) Appl. No.: 12/718,151

(22) Filed: Mar. 5, 2010

(51) Int. Cl. B32B 15/04; B32B 9/04; B32B 5/00; B32B 5/16; B32B 15/00

(52) U.S. Cl. 428/656; 428/697; 428/332; 428/329; 428/457; 428/469

(57) ABSTRACT

An article comprises a first outer layer; a second intermediate layer; and a substrate; wherein the second intermediate layer contacts the first outer layer at a first interface and the substrate at a second interface. The first outer layer comprises Al₂O₃—TiO₂ and the second intermediate layer comprises a functionally graded material. The functionally graded material comprises a composition proximate the first interface being substantially free of Al₂O₃—TiO₂ and at the second interface having Al₂O₃—TiO₂ in amounts substantially equal to the first outer layer.

### BACKGROUND OF THE INVENTION

The invention relates generally to a coated article. In particular, the invention relates generally to a coated article in the form of a turbine component. Moreover, the invention relates generally to a coated article in the form of a turbine component where the coatings provide erosion and sticking resistance to the turbine component.

Erosion can be created in and on a turbine component, such as, but not limited gas turbine buckets and nozzles. The erosion may be evident when burning ash-forming fuels that contain vanadium (V), in excessive amounts, to the extent that vanadium containing ash can cause erosion on those parts. The fuel need not necessarily comprise vanadium, but any fuel that is combusted and forms ash-bearing combustion gases.

A gas turbine that burns heavy fuel oil (HFO) containing high levels of V (>100 ppm) may be prone to impact and erosion from the ash produced due to reaction of vanadium and a magnesium inhibitor, which is added to the these fuels for inhibiting corrosion. The impact of these ash particulates and its erosive action may result in loss of turbine component material, possibly affecting the integrity of the turbine components. The turbine components in some cases can have coatings that are applied in an attempt to protect the turbine component from oxidation; however, some of these may not be adequate to resist the impact and erosion of the ash.

### BRIEF DESCRIPTION OF THE INVENTION

Briefly, in accordance with one aspect of the invention, an article comprises a first outer layer; a second intermediate layer; and a substrate. The second intermediate layer contacts the first outer layer at a first interface and the substrate at a second interface; and further the first outer layer comprises Al₂O₃—TiO₂. The second intermediate layer comprises a functionally graded material, the functionally graded material comprising a composition proximate the first interface being substantially free of Al₂O₃—TiO₂ and at the second interface having Al₂O₃—TiO₂ in amounts substantially equal to the first outer layer.

Briefly, in accordance with another aspect of the invention, an article comprises a first outer layer; a second intermediate layer; and a substrate. The second intermediate layer contacts the first outer layer at a first interface and the substrate at a second interface; and the first outer layer comprises Al₂O₃—TiO2. The second intermediate layer comprises yttrium-stabilized zirconia.

Briefly, in accordance with a further aspect of the invention, an article comprises a first layer and a substrate. The first layer comprises NiCr—Cr₂C₃ material, where the NiCr—Cr₂C₃ material provides erosion and sticking resistance.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an exemplary coating, as embodied by the invention;

FIG. 2 is a schematic illustration of another exemplary coating, as embodied by the invention; and (Layer 1 should include the 150 also, see revised FIG. 2)

FIG. 3 is a schematic illustration of another exemplary coating, as embodied by the invention. (Layer 1 should read NiCr—Cr2C3, see revised FIG. 3)

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items.

The terminology used herein is for describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

An aspect of the invention, for example but in no way limiting of the invention, is to provide a coating that presents enhanced erosion and/or impact resistance. These coatings present enhanced erosion and/or impact resistance coatings, as embodied by the invention, to an article. For example, the article, as embodied by the invention, can comprise a turbine component. The turbine component can be a gas turbine component, such as but not limited to a bucket, vane, nozzle, liner, part of a gas turbine combustion system, combustor, transition piece, blade or any other hot gas path component of a turbine, including of a gas turbine, the specification will refer to a turbine component or “article” for a non-limiting reference to the invention.

The coatings, as embodied by the invention, present enhanced erosion and/or impact resistance coatings, can be used for turbines that can use heavy fuel oil (HFO), where V levels in these heavy fuel machines is below about 100 ppm and typically in a range from about 20 to about 60 ppm. Accordingly, the coatings, as embodied by the invention, that present enhanced erosion and/or impact resistance coatings can avoid turbine part premature refurbishment that can occur before the normal intervals.

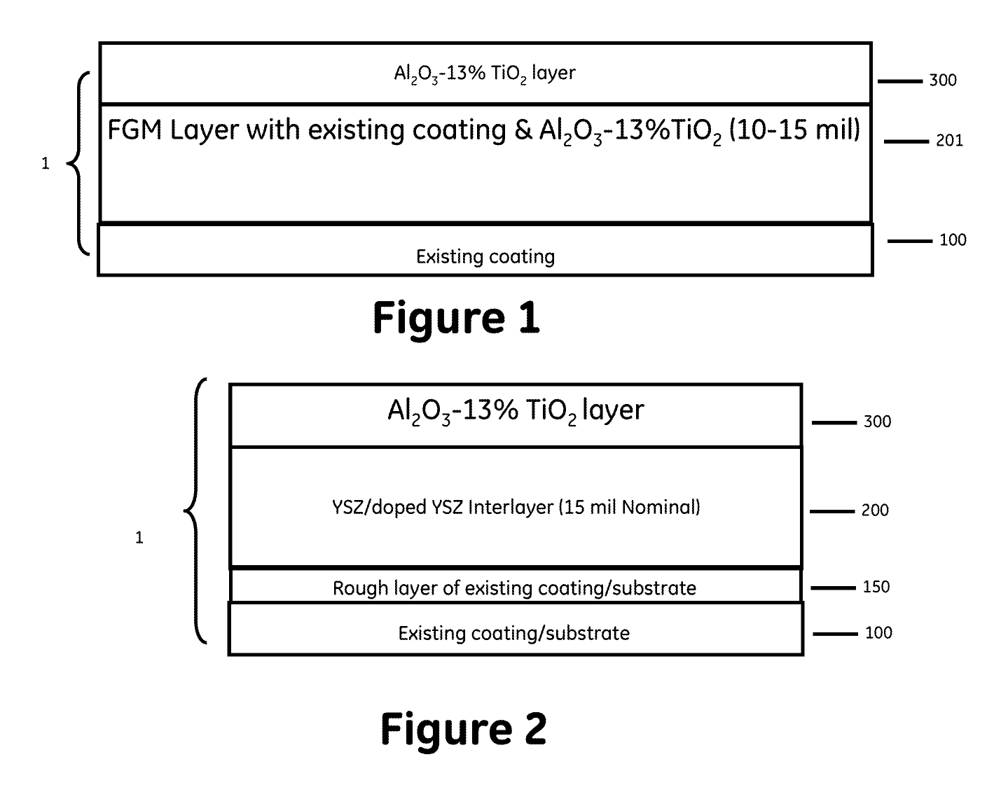

One aspect of the invention provides an erosion resistant ceramic outer coating on an MCrAlY substrate that forms part of the turbine component. With reference to the figures, the ceramic coating 1 (as illustrated in FIGS. 1, 2, and 3), as embodied by the invention, will generally exhibit a smoothness, which is equivalent to or smoother than the substrate 100 or metallic part to which it is applied. The substrate can comprise a MCrAlY turbine component.

The smoothness of the ceramic coating 1, as embodied by the invention, can be retained in use of the turbine component over time because of the coating's erosion resistance, compared to the metallic substrate of the turbine component and any existing turbine component coating. The metallic substrate 100 of the turbine component or any existing turbine component coating 100 (FIG. 2) could start out relatively smooth, but would become relatively roughened and less smooth over use of the turbine component. Use of the turbine component causes the smooth nature of the turbine component to be roughened by erosion, such as but not limited to, ash erosion. The erosion can lead to more fouling of the turbine component.

As embodied by the invention, particles, such as ash particles formed during combustion of the fuel for the turbine, may rebound from a known hard ceramic coating and not stick to the coating. The coating 1, as embodied by the invention, can comprise at least one of alumina, alumina-titania, NiCr—Cr₂C₃, and doped/rare earth stabilized zirconia, layered structures of the above.

This ceramic coating, as embodied by the invention, can be applied by high velocity air plasma spray guns with feedstock powder size in the range between about 5 and about 45 micrometers. It is envisioned that such a process will produce smooth coatings with surface Ra˜100 micro-inch.

The thickness of the ceramic coating 1, as embodied by the invention, has a range between about 0.002 to about 0.010 inch, or at least about 10 mil, or at least about 10 mil or a thickness of about 10 mil to about 15 mil. The ceramic coating 1 that can be referred to as an erosion resistant anti-stick or first outer layer 300 comprises is Al₂O₃—TiO₂ coating. The TiO₂ composition of the first outer layer 300 can vary from a range between about 0 to about 20%, for example in a range from about 0 to about 13%.

The coating, as embodied by the invention, comprises a second intermediate layer 200 or 201. The second intermediate layer 200 or 201 contacts the first outer layer 300 at a first interface and the substrate 100 at a second interface.

As illustrated in FIG. 1, the second intermediate layer 201 can be applied as a functionally graded material on a substrate/existing coating. This functionally graded material in second intermediate layer 201 comprises a Al₂O₃—TiO₂ coating, where the TiO₂ varies from essentially about 0 to about 20%, for example in a range from about 0 to about 13%, where the TiO₂ is graded or varies from essentially 0 at the first interface at the substrate 100 to about 20% and for example in a range from about 0 to about 13%, at the a second interface with the outer first layer.

Alternately, and according to a further aspect of the invention, the second intermediate layer 200 can comprise a yttrium-stabilized zirconia (YSZ) material that comprises rare earth elements. These rare earth elements can comprise at least one of tantalum Ta, ytterbium Yb, cerium Ce, and/or scandium Sc. These rare earth elements can aid in better adhesion of the second intermediate layer 200.

The ceramic coating 1, as embodied by the invention, can be capable of withstanding temperatures and environments seen in most all stages of a gas turbine.

The ceramic coating 1, as embodied by the invention, can have at least one of the first outer layer and the second intermediate layer comprise powder. The powder can be provided as a powder material with a diameter in the range between about μ5 m to about μ45 m.

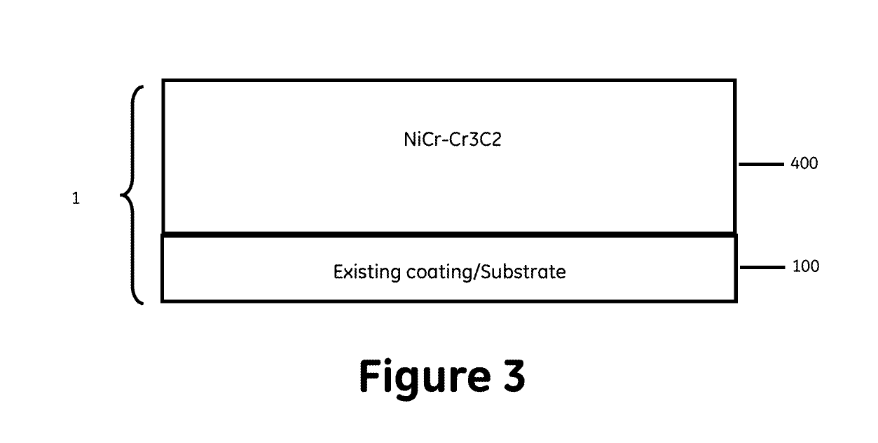

In a further aspect of the invention, FIG. 3 illustrates that a coating, as embodied by the invention, for use at stage 2 of a gas turbine and higher temperature stages comprises NiCr—Cr₂C₃. This coating 400 has a single layer architecture on a substrate 1 and any existing coating (not illustrated in this embodiment with in the scope of the invention). The coating 400 can be capable of withstanding temperatures at the second and higher stages of a gas turbine compared to those of the first stage of a gas turbine.

The hot gas path components, such as but not limited to a bucket, vane, nozzle, liner, part of a gas turbine combustion system, combustor, transition piece, blade or any other hot gas path component for gas turbines that can be operated by burning heavy fuel oil (HFO). These gas turbines are coated with a coating 1, as embodied by the invention, and will protect the turbine components from the impact/erosion/fouling damage due to the ash/particulate matter produced inside the turbine. The coating, as embodied by the invention, is intended for application to gas turbines burning HFO containing vanadium (V) levels higher than about 100 ppm.

The coating 1 chemistry, as embodied by the invention, is selected for inertness with respect to the inhibited V-environments, resistance to ash erosion, and can be applied using fine powder and a high-velocity air plasma spray process. Accordingly, the coating 1 can produce a dense, smooth coating to resist fouling/sticking by the ash in the hot gas path of a gas turbine.

The advantage of applying the impact resistant and anti-stick erosion resistant coating 1, as embodied by the invention, is to extend hot gas path and gas turbine component life. Thus, these components can survive for an expected repair interval. Also, if a gas turbine is provided with the coating 1, as embodied by the invention, ash removal by a water wash should be less frequent, allowing turbine operating or “uptime” where the turbine can generate more electricity.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article comprising:
a first outer layer;
a second intermediate layer; and
a substrate;
wherein the second intermediate layer contacts the first outer layer at a first interface and the substrate at a second interface;
the first outer layer comprises Al₂O₃—TiO₂ and
the second intermediate layer comprises a functionally graded material, the functionally graded material comprising a composition proximate the first interface being substantially free of Al₂O₃—TiO₂ and at the second interface having Al₂O₃—TiO₂ in amounts substantially equal to the first outer layer.

2. The article according to claim 1, wherein the first outer layer comprises Al₂O₃—TiO₂, with the amount of TiO2 being about 20% of the first layer.

3. The article according to claim 1, wherein the second intermediate layer comprises a thickness of at least about 10 mil.

4. The article according to claim 3, wherein the second intermediate layer comprises a thickness of at least about 15 mil.

5. The article according to claim 1, wherein the second intermediate layer comprises a thickness of about 10 mil to about 15 mil.

6. The article according to claim 1, wherein the substrate comprises a MCrAlY turbine component.

7. The article according to claim 1, wherein the substrate comprises a base layer and a coating layer on the base layer.

8. The article according to claim 1, wherein at least one of the first outer layer and the second intermediate layer comprise powder with a diameter in the range between about μ5 m to about μ45 m.

9. An article comprising:
a first outer layer;
a second intermediate layer; and
a substrate;
wherein the second intermediate layer contacts the first outer layer at a first interface and the substrate at a second interface;
the first outer layer comprises Al₂O₃—TiO2 and
the second intermediate layer comprises yttrium-stabilized zirconia.

10. The article according to claim 9, wherein the yttrium-stabilized zirconia of the second intermediate layer further comprises rare earth doping constituents.

11. The article according to claim 9, wherein the rare earth doping constituents comprise at least one of tantalum, ytterbium, cerium, and scandium.

12. The article according to claim 9, the second intermediate layer comprises a thickness of at least about 10 mil.

13. The article according to claim 9, the second intermediate layer comprises a thickness of at least about 15 mil.

14. The article according to claim 9, wherein the substrate comprises a base layer and a coating layer on the base layer.

15. The article according to claim 9, wherein the first layer comprises Al₂O₃—TiO₂.

16. The article according to claim 15, wherein the first outer layer comprises the Al₂O₃—TiO2, with the amount of TiO2 being about 20% of the first layer.

17. The article according to claim 9, wherein the substrate comprises a MCrAlY turbine component.

18. An article comprising:
a first layer;
a substrate;
wherein the first layer comprises NiCr—Cr₂C₃ material, the NiCr—Cr₂C₃ material provide erosion and sticking resistance.

19. The article according to claim 18, wherein the substrate comprises a MCrAlY turbine component.
